(19) United States
(12) Patent Application Publication
(10) Pub. No.: US 2015/0101688 A1
(43) Pub. Date: Apr. 16, 2015

(54) Flow Restrictor with Ball and Throttle

(71) Applicant: Robert Bosch GmbH, Stuttgart (DE)

(72) Inventor: Helmut Giessauf, Salzburg (AT)

(73) Assignee: Robert Bosch GmbH, Stuttgart (DE)

(21) Appl. No.: 14/391,832

(22) PCT Filed: Mar. 28, 2013
(86) PCT No.: PCT/EP2013/056777

§ 371 Date: Oct. 10, 2014

(30) Foreign Application Priority Data
Apr. 10, 2012 (AT) 423/2012

(51) Int. Cl. F02M 63/00; F16K 1/44; F16K 47/10; F16K 15/04

(52) U.S. Cl. CPC F02M 63/0054; F16K 15/044; F02M 63/0036; F16K 1/443; F16K 47/10
USPC 137/539; 137/535

(57) ABSTRACT

A device for limiting the feed of fuel out of a high-pressure supply via a controllable injector into the combustion space of an internal combustion engine comprises a housing including a pressure supply-side housing inlet, an injector-side housing outlet, and at least one duct having a throttle, and a closing member longitudinally displaceable in a chamber between an initial position and an end position, spring-prestressed opposite to a flow direction, and configured to control a flow connection between the housing inlet and the housing outlet. The housing inlet is connected to the housing outlet via the at least one duct, and the at least one duct runs radially outside the chamber.

The invention relates to a device for limiting the feed of fuel out of a high-pressure supply via a controllable injector into the combustion space of an internal combustion engine, comprising a housing with a pressure supply-side housing inlet and an injector-side housing outlet, which are connected hydraulically to one another via at least one duct having a throttle, and a closing member which is longitudinally displaceable in a chamber between an initial position and an end position and is spring-prestressed opposite to the flow direction and which controls a flow connection between the housing inlet and the housing outlet.

In injection systems with high system pressures, for example common rail systems, in unfavorable circumstances leakages may occur, whether in the line system or as a result of defective injection valves. Injection valves with jamming nozzle needles which lead to continuous injections into the combustion space may cause considerable damage. This damage may result in a fire in the vehicle or in the destruction of the engine.

To avoid these risks, flow rate restrictors with a closing function are known, which, when a maximum rate of extraction from the high-pressure supply is overshot, close the inflow to the affected injector and consequently uncouple the injection pump-side high pressure from the injection valve side.

DE 2207643 A1 discloses a flow rate restrictor which is interposed between a fuel pressure accumulator and an injection valve. This flow rate restrictor is composed of a cylinder or chamber in which a piston-like closing member is displaceable. The piston is subjected to the flow of fuel on the high-pressure accumulator side and is thereby pressed toward the injector side counter to the force of the spring. A duct connecting the two ends of the cylinder and having a throttle point runs through the piston. In normal operation, the piston is initially in its position of rest, that is to say against the stop on the side of the high-pressure accumulator. As a result of injection, the pressure on the injector side falls slightly, and as a consequence of this the piston is moved in the direction of the injector. The extraction of volume by the injector is not compensated by the throttle, but instead by the volume displaced by the piston, since the throttle is too small for such rapid compensation. In normal operation, the piston stops just short of the sealing seat, that is to say the closure of the line. The spring and the throttle are dimensioned such that, in the case of a maximum injection quantity (including a safety quantity), the piston can arrive again at the stop on the side of the high-pressure accumulator when, in the rest phase of the injector, fuel continues to flow through the throttle and thus compensates the pressure difference. The piston therefore moves constantly back and forth between a high-pressure accumulator-side initial position and an injection valve-side end position under the control of differential pressure.

In the event of any fault, that is to say a greater throughflow, the piston is pressed into the sealing seat during extraction by the injector. The piston then remains there until the switch-off of the engine and consequently closes the inflow to the injector.

Versions operating in a similar way which have a closing member formed as a ball are also known. A ball is pressed onto a stop in a bore and, as a result of the flow occurring during injection, moves in the direction of a sealing seat on account of the pressure difference when the flow passes around the ball. If a maximum injection quantity is overshot, the ball goes into the seat and prevents further flow into the injector, with the result that continuous injection is prevented.

Further variants in which a cone assumes the function of the ball are known.

The designs described have the disadvantage that functioning can be organized according to requirements for a stipulated fuel viscosity only. If viscosities are too high, the flow restrictor closes at injection quantities which are too small. Viscosities which are too low entail a failure of the closing function when the injection pressures are low.

The present invention is therefore aimed at ensuring the closing function in a broadened viscosity range. The invention is aimed, further, at increasing the wear resistance.

To achieve this object, the flow rate restrictor of the type initially mentioned is developed, according to the invention, essentially in such a way that the at least one duct runs radially outside the chamber. The duct is in this case preferably arranged in such a way that it connects the inlet-side and the outlet-side end of the housing to one another outside the chamber. It is essential that the duct does not run either through the chamber or through the closing member, since, according to the invention, the intention is to prevent the flow from passing around or through the closing member. The invention relates to replacing the pressure drop, which occurs in the conventional embodiments initially described when the flow passes around or through the closing member and which is viscosity-dependent, by the pressure drop at a throttle, this pressure drop being independent of viscosity. In addition, the likewise viscosity-dependent return stroke movement of the closing member is avoided, since the closing member does not move in the case of permissible injection quantities. Closing of the flow restrictor takes place only after a stipulated maximum injection quantity is overshot or during continuous injection.

There is preferably provision whereby the chamber is connected on the pressure supply side to the housing inlet and on the injector side to the housing outlet.

In a particularly preferred design, the chamber is formed in a cylindrical component, the outer casing of which is arranged at a radial distance from a cylindrical inner wall of the housing so as to form an annular duct and the pressure supply-side inflow orifice of which is arranged at an axial distance from the housing inlet, the annular duct being connected to the chamber via at least one throttle bore passing through the cylindrical component.

Advantageously, the chamber has a first seat surface which faces the housing inlet and with which the closing member cooperates in the initial position, and a second seat surface which faces the housing outlet and with which the closing member cooperates in the end position, the throttle bore issuing in an axial region of the chamber, said axial region being arranged between the first and the second seat surface. The closing member is preferably formed by a ball.

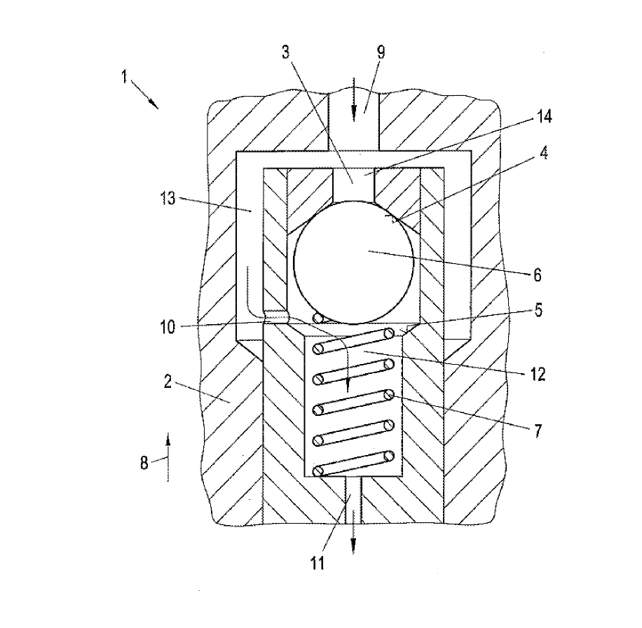

The invention is explained in more detail below by means of an exemplary embodiment illustrated diagrammatically in the drawing. FIG. 1 in this case shows a sectional illustration of the device according to the invention.

In FIG. 1, 1 designates a flow restrictor according to the invention which has a chamber 3 arranged in a housing 2. An upper sealing seat 4 and a lower sealing seat 5 for a closing member 6, here essentially spherical, are arranged in the chamber 3. The ball or closing member 6 is pressed into the upper sealing seat 4 by the force of a compression spring 7 in the direction of the arrow 8 opposite the flow direction of the fuel. During operation, fuel flows from the pressure supply-side housing inlet 9, which is connected, for example, to a high-pressure accumulator, through the throttle 10 to the injector-side housing outlet 11. As a result of the throttle 10, a pressure loss occurs between the space above the upper sealing seat and the spring space 12. When a defined throttle throughflow is overshot, the ball 6 moves in the direction of the lower sealing seat 5, counter to the spring force, on account of the pressure difference and consequently terminates injection. The end of injection can be set by varying the spring force, the diameter of the throttle 10 and the upper sealing seat diameter.

It is essential in the present invention that the branch line 13, which leads to the throttle 10, is arranged at a distance from the inflow orifice 14, and the throttle 10 is therefore arranged outside the chamber 3, as a result of which the viscosity-independent functioning of the device according to the invention is achieved.

1. A device for limiting the feed of fuel out of a high-pressure supply via a controllable injector into the a combustion space of an internal combustion engine, comprising:
a housing including a pressure supply-side housing inlet, an injector-side housing outlet, and at least one duct having a throttle; and
a closing member is longitudinally displaceable in a chamber between an initial position and an end position, spring-prestressed opposite to a flow direction, and configured to control a flow connection between the housing inlet and the housing outlet,
wherein the housing inlet is connected to the housing outlet via the at least one duct; and
wherein the at least one duct runs radially outside the chamber.

2. The device as claimed in claim 1, wherein the chamber is connected on a pressure supply side to the housing inlet and on an injector side to the housing outlet.

3. The device as claimed in claim 1, wherein the duct connects an inlet-side and the an outlet-side end of the housing to each other outside the chamber.

4. The device as claimed in claim 1, further comprising:
a cylindrical component that defines the chamber and includes an outer casing positioned at a radial distance from a cylindrical inner wall of the housing; and
an annular duct defined between the outer casing and the cylindrical inner wall of the housing,
wherein the cylindrical component defines a pressure supply-side inflow orifice located at an axial distance from the housing inlet; and
wherein the annular duct is connected to the chamber via at least one throttle bore passing through the cylindrical component.

5. The device as claimed in claim 4, wherein the chamber includes:
a first seat surface facing the housing inlet, wherein closing member is configured to cooperate with the first seat surface in the initial position; and
a second seat surface facing the housing outlet, wherein the closing member is configured to cooperate with the second seat surface in the end position,
wherein the at least one throttle bore extends in an axial region of the chamber, the axial region positioned between the first seat surface and the second seat surface.

6. The device as claimed in claim 1, wherein the closing member is configured as a ball.
